(19) United States
(12) Patent Application Publication
(10) Pub. No.: US 2017/0259441 A1
(43) Pub. Date: Sep. 14, 2017

(54) Blade with Hourglass Notch

(71) Applicant: Thomas John Scimone, San Jose, CA (US)

(72) Inventor: Thomas John Scimone, San Jose, CA (US)

(21) Appl. No.: 15/066,861

(22) Filed: Mar. 10, 2016

(51) Int. Cl. B26B 21/56; B26B 21/58; B26B 9/00

(52) U.S. Cl. CPC B26B 21/56; B26B 9/00; B26B 21/58

(57) ABSTRACT

The present invention generally relates to blades. Specifically, embodiments of the present invention relate to blades with an hourglass notch in which the hourglass notch functions to secure the blade onto a utility application.

### FIELD OF INVENTION

The present invention generally relates to a ceramic blade comprising of an hourglass notch in which such hourglass notch functions as a quick and convenient blade-fixing feature.

### BACKGROUND OF INVENTION

Ceramic blades are becoming increasing popular as an alternate to metal blades due to certain advantages. Since ceramic is the second hardest material after diamond, ceramic blades last longer than metal blades. This durability translates into a resistance against blunting. Accordingly, a ceramic blade can maintain its sharpness significantly longer than a metal blade, making it an economical choice. Additionally, ceramic blades are typically thicker than metal blades in performing identical functions making them easier to handle. For example, the thicker ceramic blade is easier to grasp than a flatter, thinner blade during blade change resulting in less injuries. Thus, a ceramic blade is a more cost-effective and safer alternative to metal blades.

On the other hand, the main disadvantage to ceramics is its brittleness. At the atomic level, ceramic is usually ionic or covalently bonded material. This translates into poor toughness and increase fracturability. Since ceramic can break easily, this limits the quantity and type of structural modifications that can be made with the material.

Thus, despite the advantages of a ceramic blade, it may have limited versatility. For example, based on current knowledge, it is not cost effective to manufacture replaceable ceramic blades for utility scrapers. To be replaceable, such blade scrapers need a means for easy removal and affixing onto the utility scrapers. Conventionally, a utility scraper with a replaceable metal blade employs metal blades with notches/and or holes. These features enable the metal blade to fix into the utility scraper device. However, with respect to ceramic blades a hole cannot be drilled into the center of a blade without weakening the structural integrity of the blade. Even if structural integrity is not an issue, drilling a whole in the center of a blade is not economically feasible since the yield in production drops. The translates into a higher cost product when the competing and traditional product is significantly cheaper.

Thus, there is a need in the art for a means of securing a ceramic blade into a device to enable it for easy removal without compromising on the structural integrity on the ceramic blade. This and other features and advantages of the present invention will be explained and will become obvious to one skilled in the art through the summary of invention that follows.

### SUMMARY OF INVENTION

Accordingly, it is an aspect of the present invention to provide a ceramic blade with a mounting feature that facilitates removal and insertion while maintaining the structural integrity of the ceramic blade.

According to an embodiment of the present invention, a ceramic blade comprising an hourglass notch.

According to an embodiment of the present invention, the ceramic blade is further comprised of rounded corners.

According to an embodiment of the present invention, the ceramic blade is further comprised of pointed corners.

According to an embodiment of the present invention, the ceramic blade is configured as a scraping blade.

According to an embodiment of the present invention, the ceramic blade is configured as a razor blade.

According to an embodiment of the present invention, the ceramic blade is configured as a craft knife blade.

According to an alternate embodiment of the present invention, the ceramic blade is comprised of a first edge, further comprising of an hourglass notch to enable mounting of said blade onto a utility apparatus, and an opposite second edge comprising of a cutting part.

According to an alternate embodiment of the present invention, the ceramic blade is further comprised of a rounded corners on the second edge.

According to an alternate embodiment of the present invention, the ceramic blade is comprised of pointed corners on the second edge.

According to an alternate embodiment of the present invention, the ceramic blade is comprised of rounded corners along the first and second edges.

According to an alternate embodiment of the present invention, the ceramic blade is comprised of pointed corners along the first and second edges.

According to an alternate embodiment of the present invention, the hourglass notice is centrally located along a length of the first edge.

According to an alternate embodiment of the present invention, the ceramic blade is configured as a scraping blade.

According to an alternate embodiment of the present invention, the ceramic blade is configured as a razor blade.

According to an alternate embodiment of the present invention, the ceramic blade is configured as a craft knife blade.

### BRIEF DESCRIPTION OF THE DRAWINGS

FIG. 1 is a perspective view of a ceramic blade with an hourglass notch in accordance with an embodiment of the present invention.

FIG. 2 is a front view of a ceramic blade with an hourglass notch in accordance with an embodiment of the present invention.

FIG. 3 is a top view of a ceramic blade with an hourglass notch in accordance with an embodiment of the present invention.

FIG. 4 is a bottom view of a ceramic blade with an hourglass notch in accordance with an embodiment of the present invention.

FIG. 5 is a side view of a ceramic blade with an hourglass notch in accordance with an embodiment of the present invention.

FIG. 6 is a perspective view of a ceramic blade with an hourglass notch in accordance with an embodiment of the present invention.

FIG. 7 is a front view of a ceramic blade with an hourglass notch in accordance with an embodiment of the present invention.

FIG. 8 is a top view of a ceramic blade with an hourglass notch in accordance with an embodiment of the present invention.

FIG. 9 is a bottom view of a ceramic blade with an hourglass notch in accordance with an embodiment of the present invention.

FIG. 10 is a side view of a ceramic blade with an hourglass notch in accordance with an embodiment of the present invention.

FIG. 11 is a perspective view of the ceramic blade with an hourglass notch in accordance with an embodiment of the present invention.

### DETAILED SPECIFICATION

Steel has been the predominant blade of choice for various cutting applications. Steel is sufficiently durable to cut the desired materials without easily deforming. A typical cutting apparatus will employ a steel blade by embedding the blade within the apparatus utilizing a plurality of notches—at least one on each side. These notches act to stabilize the steel blades so they are securely affixed to the apparatus and prevented from sliding out. While similar notches may be carved into ceramic blades, the brittle tendency of ceramic can destabilize the entire ceramic blade. Thus, a solution was needed to affix ceramic blades into cutting apparatus without compromising on the structural integrity of the blade. Accordingly, the claimed invention relates to ceramic cutting blades with a unique mounting feature that is able to maintain the durability of the cutting blade and facilitate the installation and removal of such blade from a cutting device such as a utility scraper, utility knife, craft knife, box cutter, and or other cutting tools.

According to an embodiment of the present invention, a ceramic cutting blade comprises of an hourglass notch. According to the preferred embodiment of the claimed invention, a ceramic blade comprising of (i) a first edge comprising of an hourglass notch to enable mounting of said blade onto a utility apparatus (e.g. a cutting device) and (ii) an opposite second edge comprising of a cutting party. In further alternate embodiments, the ceramic cutting blade may be comprised of more or fewer components. One of ordinary skill in the art would appreciate that a ceramic cutting blade could be operably configured with a variety of components, and embodiments of the present invention are contemplated for use with any such component.

In detail, the hourglass notch of the ceramic blade comprises of a narrow opening that flares out to a wider, bulbous body. The primary function of this hourglass notch is to serves as a mounting means for the ceramic blade. As an illustration, the hourglass notch matches a similarly shaped projection on a cutting device for the insertion of the blade. The narrow openings provides some resistance before the ceramic blade springs into position with a comfortable click feel and engages with the projection. With the blade now fixed into position, it can be employed for whatever suitable means intended by the cutting device. Due to the narrower opening of the hourglass notch, the blade is fixed in position and precluded from sliding out, thereby ensuring a secure fit.

According to an embodiment of the claimed invention, the hourglass shape allows for motion along the Y and Z planes (with the X plane parallel to a cutting surface) and possible rotation about an angle Φ. The movability of the ceramic blade is limited because the hourglass notch is used to fix the ceramic blade into position. Therefore, the hourglass notch has the following additional effects: (i) restrict movement along the X—axis and (ii) control movement along the Y—axis. Restrictions along the X—axis are imparted from the shape of the bulbous body. The size (i.e. circumference) of the bulbous portion of the hourglass notch is set so it engages with the cutting device's protrusion and secures a tight fight. Thus, movement along an X—axis is just not possible with a bulbous shaped notch. Further, the narrow opening of the hourglass notch prevents the escape of the ceramic blade along the Y—axis. The blade can be removed if additional (e.g. manual) force is applied to the ceramic blade so the protrusion squeezes through the opening. Without additional force, movement along the Y—axis is severely curtailed. The bulbous shape also permits the additional effect of rotation about an angle Φ, wherein the point of rotation is the center of the bulbous body (or the center of a protrusion engaged with the hourglass notch). This rotation allows the blade to be swing back and forth and along for an alternate plane for removal along the Z-axis.

In further alternate embodiments, the ceramic cutting blade with hourglass notch is constructed from a ceramic material that is capable of withstanding extended use without becoming dull or unusable. Ceramic materials appropriate for such construction include, but are not limited to, Zirconium Oxide. One of ordinary skill in the art would appreciate that there are numerous ceramic materials that could be utilized with embodiments of the present invention.

Based on the brittle property of ceramic materials, an hourglass notch in ceramic blades provides a means for replacing worn blades, allowing the ceramic blade to remain fix in a secure position, and provide a cost effective means for the manufacture of ceramic blades. Ceramic is a suitable alternative to steel for blade formation because it is more durable (harder) than steel. According to Mohs scale of hardness where the hardest substance, diamond, ranks 10, ceramics rate 7-8.5 whereas steel measures 4-4.5. Therefore, due to the relative softness of steel, steel blades dull and require repeated sharpening or replacement where as a ceramic blade is generally as effective after the 100^{th} use as it is on the first use. However, the drawback to ceramic is that it is brittle. Drilling a hole in ceramic blades similar to holes in steel blades for convenient replacement weakens the structural integrity of the blade and promote fracturing of such blades. The fracture toughness of ceramics is can be anywhere from 0.2 to 5 K_{lc}, whereas the fracture toughness of a steel allow is approximately 50 K_{lc}. Thus, less energy is required to drive cracks through a ceramic material than to achieve the same amount of defects in steel.

Accordingly, an hourglass notch along centrally located along the first edge provides the best solution to produce replaceable ceramic blades with the least sacrifice to structural integrity. If the ceramic blade contained a hole in its center, a feature that is typical of the prior art, then the hole imparts localized stress completely surrounding the circumference of the hole making it more unstable and weak. In greater detail, the primary difference between a ceramic blade with an hourglass notch at the surface and a ceramic blade with a centrally located hole is the latter has relatively increased porosity. When a notch or hole is centrally located, this adds to the volume of defects in the ceramic blade that is empty or without material. In contrast, a surface notch, is not a “defect” within the ceramic blade because it is a carved out edge; edge deformities can be controlled with proper tooling/polishing and machining whereas an internal defect cannot easily be corrected. Therefore, there is little to none driving force to propagate a crack and the relatively porosity of a ceramic blade with an hourglass notch at the surface is virtually identical to the same ceramic blade without a notch. Since the modus of rupture—a measure of a material's bending strength before rupture—decreases as porosity increase, it is clear that the surface hourglass notch blade is less likely to fracture than a ceramic blade with a centrally located hole.

According to a preferred embodiment of the present invention, each end of the second edge is rounded. In the preferred embodiment, each end of the second edge is rounded so that the blade is safer to handle. In particular, rounded edges are safer than edges that come to a point at an angle that creates a sharp point. In this manner, the ceramic blades reduce the risk of puncturing a user or bystander as well as making changing and installing new blades a lower risk proposition than with traditional pointed edges blades. One of ordinary skill in the art would appreciate that that there are numerous configurations for a second edge with rounded ends, and embodiments of the present invention are contemplated for use with any such configuration.

According to a preferred embodiment of the present invention, at least one end of the second edge is pointed. In particular, at least one pointed edge is preferred for a cutting device such as a utility knife for use with cutting packaging or a scraping blade to peel off paint. In the preferred embodiment, each first and second end of the second edge is pointed so that the blade is more effective and convenient upon a cutting surface.

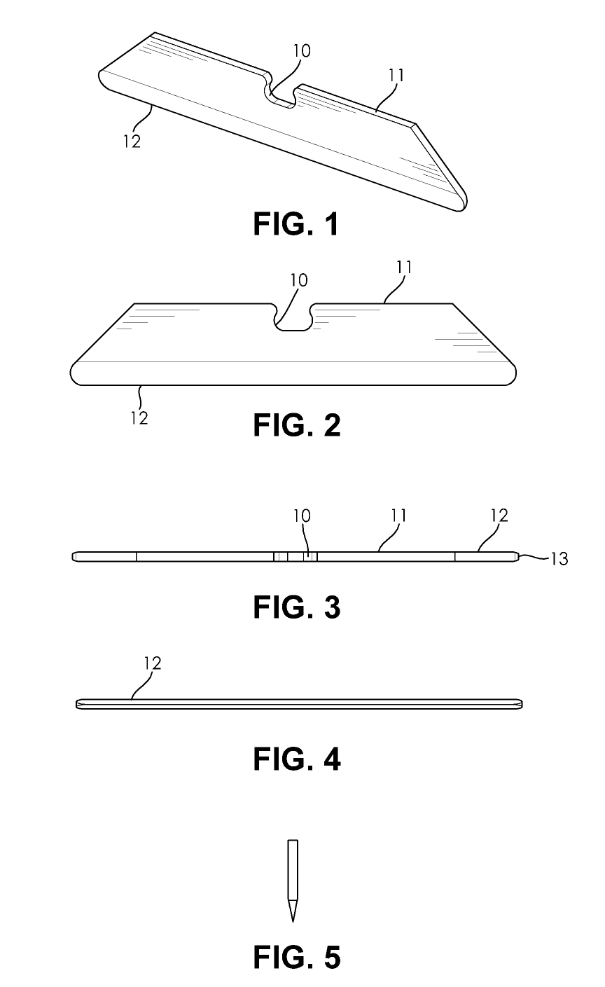

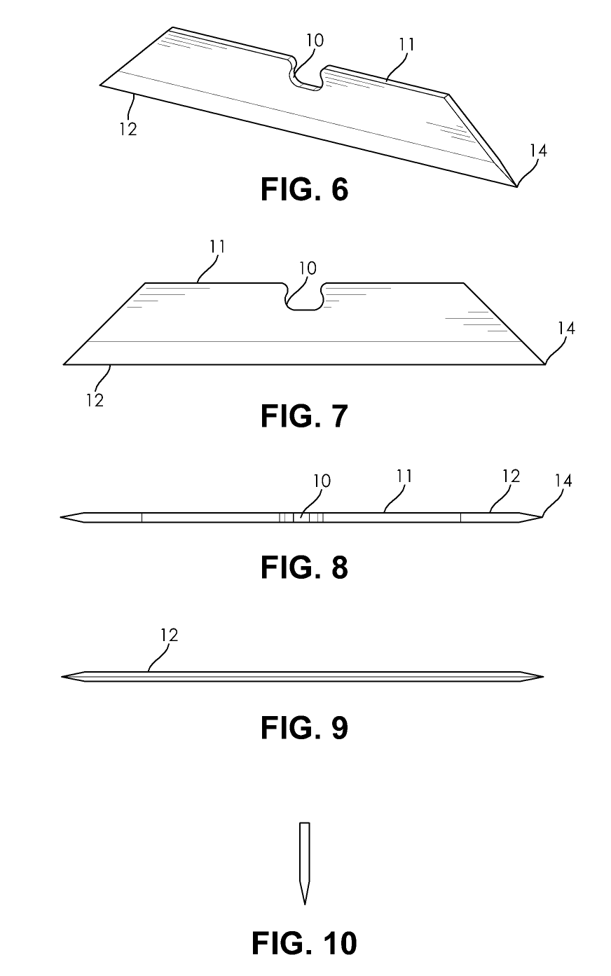

Turning now to FIG. 1 and FIG. 6, a perspective view of a ceramic blade with an hourglass shape (10), a first edge (11) and second edge (12) in accordance with embodiments of the present invention are shown. FIG. 1 shows an embodiment of a ceramic blade with rounded corners (13), whereas FIG. 6 shows the same perspective view for a ceramic blade with pointed corners (14).

FIG. 2 and FIG. 7 show a front face view of the rounded corner embodiments and pointed corner embodiments respectively. Similarly, FIG. 3 and FIG. 8 illustrate top views; FIG. 4 and FIG. 9 reveal bottom views; and FIG. 5. and FIG. 10 demonstrate side views of ceramic blades with a surface hourglass notch comprising respectively of rounded corners and pointed corners.

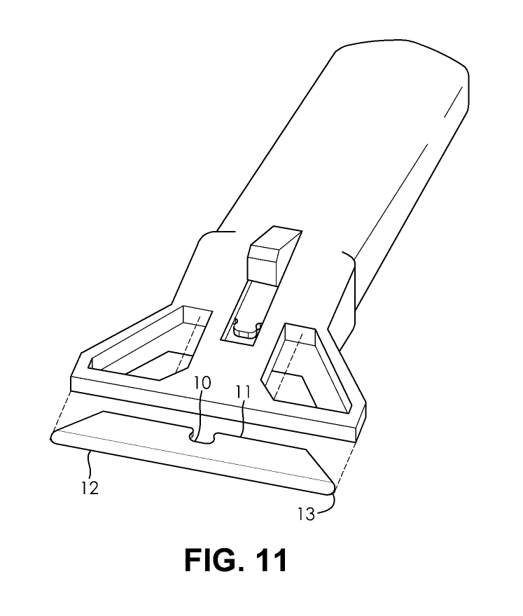

FIG. 11 serves as an illustrative example of how the claimed invention is adapted for use in a blade holding apparatus such as a utility scraper. The “female” hourglass notch (10) engages with a “male” corresponding piece on the blade holding apparatus for a secure fit.

Embodiments of the current invention have an hourglass notch to connect with a corresponding piece on the cutting device. As an example, the ceramic cutting blade is configured as a utility scraper blade and the hourglass notch is designed to be inserted into the cartridge. Exemplary dimensions of an embodiment of a ceramic utility scraper blade may be, for instance, between 30-70 millimeters (mm) in width along a top and/or bottom edge, 5-20 millimeters long from the top edge to the bottom edge; 1-2 millimeters in depth from a front side to a back side; and an hourglass notch between 3 mm-6 mm at its narrowest dimension and 4 mm-6.5 mm at its widest, most bulbous dimension. In some embodiments, the narrowest portion of the hourglass notch is one-tenth the length of the width of the blade. According to a preferred embodiment, a ceramic blade is comprised of a first edge that is 46.7 mm in length; 12 mm in length from the top edge to the bottom edge; 67 mm in length along the second edge; and 1.3 mm in thickness at the top edge. Ceramic blades in this range provide for the desirable increase in strength, durability and usability. One of ordinary skill in the art would appreciate that there are numerous other widths, lengths and heights that may be utilized with embodiments of the present invention, and embodiments of the present invention are contemplated for use with any width, length and height. These size ranges constitute a new form factor of utility knife blade. Exemplary embodiments of the utility knife blades described in this application are thicker than any utility knife blade ever made previously.

In alternate embodiments of the claimed invention, a blade is comprised of an hourglass notch. Such blade can be metal (steel, steel alloys, copper, bronze) or non-metal (stone, synthetic sapphire, glass and plastic). While multiple embodiments are disclosed, still other embodiments of the present invention will become apparent to those skilled in the art from this detailed description.

In alternate embodiments of the claimed invention, a blade is comprised of an hourglass notch at each a first edge and a second edge. Other alternate embodiments of the claimed invention include at least two hourglass notches on a first edge while other alternate embodiments include at least two hourglass notches on a first edge and a second edge.

The invention is capable of myriad modifications in various obvious aspects, all without departing from the spirit and scope of the present invention. Accordingly, the drawings and descriptions are to be regarded as illustrative in nature and not restrictive.

1. A ceramic blade comprising an hourglass notch.

2. The ceramic blade of claim 1, wherein said blade comprises of rounded corners.

3. The ceramic blade of claim 1, wherein said blade comprises of pointed corners.

4. The ceramic blade of claim 1, wherein said blade is configured as a scraping blade.

5. The ceramic blade of claim 1, wherein said ceramic blade is configured as a razor blade.

6. The ceramic blade of claim 1, wherein said ceramic blade is configured as a craft knife blade.

7. A ceramic blade comprising of:
first edge comprising of an hourglass notch to enable mounting of said blade onto a utility apparatus; and
an opposite second edge comprising of a cutting part.

8. The ceramic blade of claim 7, wherein said blade further comprises of rounded corners on the second edge.

9. The ceramic blade of claim 7, wherein said blade further comprises of pointed corners on the second edge.

10. The ceramic blade of claim 7, wherein said first edge and said second edge comprise of rounded corners.

11. The ceramic blade of claim 7, wherein said first edge and said second edge comprise of pointed corners.

12. The ceramic blade of claim 7, wherein said hourglass notch is centrally located along a length of the first edge.

13. The ceramic blade of claim 7, wherein said blade is configured as a scraping blade.

14. The ceramic blade of claim 7, wherein said ceramic blade is configured as a razor blade.

15. The ceramic blade of claim 7, wherein said ceramic blade is configured as a craft knife blade.

16. A blade comprising an hourglass notch.
